(19) United States
(12) Patent Application Publication
(10) Pub. No.: US 2026/0347680 A1
(43) Pub. Date: Nov. 5, 2026

(54) PREPARATION OF INVERT EMULSION TREATMENT FLUIDS

(71) Applicant: Halliburton Energy Services, Inc., Houston, TX (US)

(72) Inventors: Preston Andrew MAY, Porter, TX (US); Jay DEVILLE, Houston, TX (US); William W. SHUMWAY, Spring, TX (US); Veerabhadra S. DENDULURI, Austin, TX (US)

(73) Assignee: Halliburton Energy Services, Inc., Houston, TX (US)

(21) Appl. No.: 19/196,590

(22) Filed: May 1, 2025

(51) Int. Cl. C09K 8/36; B01F 23/41; B01F 23/411; B01F 31/80; B01F 101/49; C09K 8/502; E21B 21/06

(52) U.S. Cl. CPC C09K 8/36; B01F 23/4105; B01F 23/4111; B01F 23/4142; B01F 31/80; C09K 8/502; E21B 21/062; B01F 2101/49

(57) ABSTRACT

Methods and systems for preparing an invert emulsion treatment fluid. An oleaginous base fluid, an aqueous fluid, and an emulsifier are combined to provide the invert emulsion treatment fluid. The invert emulsion treatment fluid is sonicated during and/or after the combining of the oleaginous base fluid, aqueous fluid, and emulsifier. The sonication may continue until there is a desired increase in the measured electrical stability of the invert emulsion treatment fluid.

### TECHNICAL FIELD

The present disclosure relates generally to wellbore operations, and more particularly, to the preparation and use of an invert emulsion treatment fluid having a desired electrical stability.

### BACKGROUND

Drilling fluids are circulated in a wellbore, among other reasons, to remove drill cuttings, to cool and lubricate the drill bit, to assist in the support of the drill pipe and drill bit, and to provide a hydrostatic head to maintain wellbore integrity. Drilling fluids are formulated to achieve specific fluid properties needed to optimize the drilling operation in a particular geological formation. Some drilling fluids are invert emulsions with oil as the external or continuous phase and an aqueous fluid as the internal or discontinuous phase. Moreover, invert emulsions may also be used for completion fluids used to prepare the wellbore for subsequent operations after the completion of the drilling operation.

Operational issues may arise if the emulsion of the invert emulsion treatment fluid destabilizes during use. The present disclosure provides improved methods for the preparation and use of invert emulsion treatment fluids.

### BRIEF DESCRIPTION OF THE DRAWINGS

Illustrative examples of the present disclosure are described in detail below with reference to the attached drawing figures, which are incorporated by reference herein, and wherein:

FIG. 1 is a perspective drawing of method for the preparation of an invert emulsion treatment fluid in accordance with one or more examples described herein;

FIG. 2 is a perspective drawing of another method for the preparation of an invert emulsion treatment fluid where this example separates the sonicator and electrical stability tester from the vessel in accordance with one or more examples described herein;

FIG. 3 is a schematic for drilling a subterranean formation with an invert emulsion drilling fluid in accordance with one or more examples described herein;

FIG. 4 is a graph illustrating experimental data measuring the change in electrical stability from increasing specific energy in accordance with one or more examples described herein;

FIG. 5 is a graph illustrating experimental data measuring the change in electrical stability over time in accordance with one or more examples described herein;

FIG. 6 is a graph illustrating experimental data measuring the change in electrical stability from increasing specific energy on a weighted invert emulsion treatment fluid in accordance with one or more examples described herein; and

FIG. 7 is another graph illustrating experimental data measuring the change in electrical stability from increasing specific energy in accordance with one or more examples described herein.

The illustrated figures are only exemplary and are not intended to assert or imply any limitation with regard to the environment, architecture, design, or process in which different examples may be implemented.

### DETAILED DESCRIPTION

The present disclosure relates generally to wellbore operations, and more particularly, to the preparation and use of an invert emulsion treatment fluid having a desired electrical stability.

In the following detailed description of several illustrative examples, reference is made to the accompanying drawings that form a part hereof, and in which is shown by way of illustration specific examples that may be practiced. These examples are described in sufficient detail to enable those skilled in the art to practice them, and it is to be understood that other examples may be utilized, and that logical structural, mechanical, electrical, and chemical changes may be made without departing from the spirit or scope of the disclosed examples. To avoid detail not necessary to enable those skilled in the art to practice the examples described herein, the description may omit certain information known to those skilled in the art. The following detailed description is, therefore, not to be taken in a limiting sense, and the scope of the illustrative examples are defined only by the appended claims.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present invention. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit.

In the following discussion and in the claims, the terms “including” and “comprising” are used in an open-ended fashion, and thus should be interpreted to mean “including, but not limited to.” Unless otherwise indicated, as used throughout this document, “or” does not require mutual exclusivity.

The terms “uphole” and “downhole” may be used to refer to the location of various components relative to the bottom or end of a well. For example, a first component described as uphole from a second component may be further away from the end of the well than the second component. Similarly, a first component described as being downhole from a second component may be located closer to the end of the well than the second component.

The terms “upstream” and “downstream” may be used to refer to the location of various components relative to one another in regards to the flow of a sample through said components. For example, a first component described as upstream from a second component will encounter a sample before the downstream second component encounters the sample. Similarly, a first component described as being downstream from a second component will encounter the sample after the upstream second component encounters the sample.

As used herein the weight/volume (“w/v”) is to be understood to mean the weight of a solute (in units of grams) divided by the volume of solution (in units of milliliters), and the weight/volume percentage (“% w/v”) is to be understood to mean the grams/milliliters multiplied by 100.

The present disclosure relates generally to wellbore operations, and more particularly, to the preparation and use of an invert emulsion treatment fluid having a desired electrical stability. Advantageously, sonication is used to prepare an invert emulsion treatment fluid having a desired electrical stability. The electrical stability is an indicator of emulsion integrity, and can be measured in physical units of volts (V). Generally, higher electrical stability is associated with a more stable emulsion (e.g., better mixing between the phases), and lower electrical stability is an indication of an emulsion which may be more prone to failing (e.g., phase separation). As such, increasing the electrical stability of the invert emulsion may provide an improved invert emulsion treatment fluid. To achieve an invert emulsion treatment fluid with improved electrical stability, a sonicator is used to sonicate the invert emulsion treatment fluid during and/or after the combining of the emulsion components. As used herein, the term “sonicator” refers to any device that may be used to sonicate the invert emulsion treatment fluid during and/or after its preparation and this term is inclusive of ultrasonication devices. Likewise, the term “sonicate” is inclusive of both sonic and ultrasonic frequencies. For example, a description of sonicating the invert emulsion treatment fluid should be understood to involve the application of sonic energy at frequencies above, below, or at 20 kHz. Without limitation by theory, cavitation induced by sonication is believed to improve the electrical stability. As such, sonication at frequencies sufficient to induce cavitation in the invert emulsion treatment fluid is desired. Generally, the invert emulsion treatment fluid may be sonicated at frequencies between about 1 to about 170 kHz. Preferably the frequency range is between about 15 to about 25 kHz. More preferably, the frequency range is between about 18 to about 22 kHz. Additionally, the invert emulsion treatment fluid may be sonicated with more than one frequency at the same time.

Additional drilling fluid components such as polymeric additives and weighting agents may be added to the invert emulsion treatment fluid to tailor the fluid as desired. Additionally, the invert emulsion treatment fluid may be used as a seed fluid to improve the electrical stability of another treatment fluid that was not sonicated. As a further advantage, in an embodiment, the electrical stability of the invert emulsion treatment fluid may be increased solely through the use of sonication, without the need for adding further chemical additives to the invert emulsion treatment fluid solely to improve electrical stability. Thus, the invert emulsion treatment fluid does not require the use of these potentially expensive chemical additives which may also negatively affect other fluid properties. A further advantage is that the invert emulsion treatment fluid may not be a Pickering emulsion. Pickering emulsions are stabilized by solid particles only, in the absence of any other surface-active species such as surfactants, and/or polymers, and/or proteins. An emulsion is considered to be stabilized such that the continuous and discontinuous phases do not separate after the removal of agitation for at least an hour. A still further advantage is that sonication may be used to increase the electrical stability for invert emulsion treatment fluids comprising a variety of oleaginous base fluids, aqueous fluids, and emulsifiers. The invert emulsion treatment fluid may be sonicated at the wellsite or fluid plant surface prior to introduction into the wellbore. The sonication may be performed at the wellsite or at the fluid plant, sometimes referred to as a “mud plant.” Moreover, an automated system may be used. The automated system may measure the electrical stability of the invert emulsion treatment fluid and then automatically sonicate the invert emulsion treatment fluid until it achieves a desired electrical stability. The system could be configured to periodically measure and sonicate the invert emulsion treatment fluid to maintain the integrity of the emulsion until it is time for the invert emulsion treatment fluid to be used.

The invert emulsion treatment fluid is sonicated using a sonicator. Generally, it is preferable to utilize sonicators that are capable of sonicating large fluid volumes to reduce the need for batch sonication of smaller volumes. However, any sonicator configured for sonicating the invert emulsion treatment fluid during and/or after its preparation is sufficient for use with the invert emulsion treatment fluid. Generally, the sonicator should be capable of and configured to induce cavitation in the invert emulsion treatment fluid. Examples of sonicators may include, but are not limited to: ultrasonic probes, ultrasonic horns, ultrasonic vibrators, ultrasonic homogenizers; flow-through sonication, such as a flow-cell containing a sonicator; and indirect sonication (i.e., transmitting ultrasonic waves through a fluid that is indirect contact with another fluid (e.g., an ultrasonic bath). The sonicators may be used to agitate the invert emulsion treatment fluid and apply sufficient specific energy to increase the electrical stability above a desired threshold. The desired threshold value for the electrical stability will fluctuate based on the type of emulsion, the treatment fluid formulation, the operation parameters, and the type of subterranean formation. For some operations, a database may be prepared that contains known specific energy requirements corresponding to known invert emulsion treatment fluid formulations. The specific energy requirement, which can have physical units of joules/milliliter (J/mL), refers to the energy needed to prepare a stable emulsion or invert emulsion. The parameters of the sonicator may be set to apply a desired specific energy to the invert emulsion treatment fluid. General examples of some specific parameter settings may include, but are not limited to, a frequency of between about 1 to about 170 kHz, and/or an amplitude of between about 5 to about 200 microns (micrometers), and/or a power intensity of about 10 to about 400 W/cm². The power intensity is the power delivered by the sonicator probe (Watts) divided by the active area of the probe (cm²). In a specific example, the sonicator applies specific energy to the invert emulsion treatment fluid in a range of about 5 to about 200 J/mL. Without limitation by theory, it is believed that the agitation provided by sonication induces cavitation in the invert emulsion treatment fluid which may reduce the droplet size of the internal or discontinuous phase of the invert emulsion treatment fluid. This effect may improve the stability of the invert emulsion treatment fluid and this improvement may be measured by the observed increase in the electrical stability of the invert emulsion treatment fluid. Configuring the sonicator to induce cavitation in the invert emulsion treatment fluid may improve the increase in the electrical stability of the invert emulsion treatment fluid.

In some optional examples, the sonication of the invert emulsion treatment fluid may be timed to occur after measurement of the electrical stability of the invert emulsion treatment fluid. If the measured value for electrical stability is less than a desired threshold for the electrical stability value, then the invert emulsion treatment fluid may be sonicated. This process may be repeated until the measured electrical stability of the invert emulsion treatment fluid meets or exceeds the desired threshold for the electrical stability value. In a further optional example, an automated system may be used to measure the electrical stability of the invert emulsion treatment fluid with a probe or sensor and then apply a predetermined specific energy with a sonicator based on the measured electrical stability. After sonication, the electrical stability may be measured again and then sonicated again if necessary. This system would automatically continue in this process until the measured electrical stability exceeds the desired threshold electrical stability value, at which point the system would not further sonicate the invert emulsion treatment fluid and the invert emulsion treatment fluid would be marked as ready by the automated system. The automated system may comprise automating the sonicator probe such that it starts sonication. If the probe is not within the invert emulsion treatment fluid, a mechanical arm or other apparatus for placing the probe within the invert emulsion treatment fluid may be added. Once activated the probe may agitate the invert emulsion treatment fluid per the programmed parameters. A mixing component may also be added to the containing vessel to mix the invert emulsion treatment fluid before, during, or after it is sonicated. This mixing component may be any mixer sufficient for mixing the invert emulsion treatment fluid or its components. The mixing component may also be an automated part of the automated system. After the desired energy has been applied, the sonication may cease and the electrical stability may be measured automatically by a sensor of an electrical stability tester. Automated sonication may resume if the measured electrical stability is below a predetermined threshold.

Electrical stability is one potential indicator of invert emulsion stability. In other examples, other methods of measuring invert emulsion stability may be used. For example, the presence of water in the filtrate detected during fluid loss testing may also indicate invert emulsion instability. Likewise, an increase in electrical conductivity also indicates invert emulsion instability, whereas a reduction in electrical conductivity would indicate an improvement in invert emulsion stability. Additionally, electrical resistivity could be monitored to indicate emulsion stability. A treatment fluid with high electrical resistivity would indicate an improvement in emulsion stability. Further, physical separation of the oil phase and water phase can be monitored. As another example, the internal phase droplet size can be monitored by standard microscopy techniques such as light scattering. An emulsion is considered to be stabilized such that the continuous and discontinuous phases do not separate after the removal of agitation for at least an hour.

The invert emulsion treatment fluids may be used in any wellbore operation which uses invert emulsions. As an example, the invert emulsion treatment fluid may be used as a drilling fluid (e.g., a reservoir drilling fluid, a non-reservoir drilling fluid, etc.) to drill a wellbore in a subterranean formation. As another example, the invert emulsion treatment fluid may be used as a completion fluid to complete a wellbore after the drilling of the wellbore is completed. Additional examples of the invert emulsion treatment fluid may include, but are not limited to, a workover fluid, a packer fluid, a screen running fluid, a scale remediation fluid, a water shut-off fluid, fracturing fluid, gravel pack fluid, small volume fluids such as lost circulation pills, etc.

The invert emulsion treatment fluid comprises an oleaginous base fluid. The oleaginous base fluid may comprise any oleaginous fluid sufficient for forming the external or continuous phase of the invert emulsion treatment fluid. Generally, the oleaginous base fluid may include but is not limited to: a fractional distillate of crude oil; a fatty derivative of an acid, an ester, an ether, an alcohol, an amine, an amide, or an imide; a saturated hydrocarbon; an unsaturated hydrocarbon; a linear hydrocarbon; a branched hydrocarbon; a cyclic hydrocarbon; or any combination of oleaginous fluids. Crude oil may be separated into fractional distillates based on the boiling point of the fractions in the crude oil. An example of a fractional distillate of crude oil is diesel oil. The saturated hydrocarbon may be an alkane or paraffin. The paraffin may be an isoalkane (isoparaffin), a linear alkane (paraffin), a cyclic alkane (cycloparaffin), or a combination of paraffins. The unsaturated hydrocarbon may be an alkene, alkyne, aromatic, or a combination of unsaturated hydrocarbons. The alkene may be an isoalkene, linear alkene, branched alkene, cyclic alkene, or combination of alkenes. The linear alkene may be a linear alpha olefin, an internal olefin, or a combination of linear alkenes. The branched alkene may be a branched alpha olefin, an internal olefin, or a combination of branched alkenes. Specific examples of the oleaginous base fluid may include, but are not limited to, 2-butoxyethanol, 1-dodecyl-2-pyrrolidinone, methyl-9-decenoate, dimethyl succinate, dimethyl glutarate, dimethyl adipate, dimethyl-2-methylgluturate, ditertbutyl glutarate, dimethyl carbonate, dibutyl sulfate, di-terbutyl sulfate, terpenes, oil of terpentine, hexane, hydrotreated petroleum distillates, dearomatized petroleum distillates, n-hexane, n-dodecane, n-tetradecane, light mineral oil, heavy mineral oil, pure mineral oil, synthetic olefins of C12 to C24, and synthetic esters of C12 to C22, or a combination of oleaginous base fluids. Generally, the hydrotreated petroleum distillates may contain formulations having an alkane concentration of about 4% to about 8% (w/w), an alkene concentration of about 2-5% (w/w), an isoalkane concentration of about 25% to about 40% (w/w), a cycloalkane concentration of about 3% to about 7% (w/w), a cycloalkene concentration of about 1% to about 4% (w/w), and an aromatic concentration of about 20% to about 50% (w/w) of the total oil phase. Generally, the dearomatized petroleum distillates may contain formulations having an alkane concentration of about 40% to about 70% (w/w), an isoalkane concentration of about 20% to about 50% (w/w), a cycloalkane concentration of about 5% to about 20% (w/w), and an aromatic concentration of about 1% (w/w) of the total oil phase.

The concentration of the oleaginous base fluid in the invert emulsion treatment fluid may range from about 20% (w/v) to about 99% (w/v). The concentration of the oleaginous base fluid in the invert emulsion treatment fluid may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the oleaginous base fluid in the invert emulsion treatment fluid may range from about 20% (w/v) to about 99% (w/v), from about 25% (w/v) to about 99% (w/v), from about 30% (w/v) to about 99% (w/v), from about 35% (w/v) to about 99% (w/v), from about 40% (w/v) to about 99% (w/v), from about 45% (w/v) to about 99% (w/v), from about 50% (w/v) to about 99% (w/v), from about 55% (w/v) to about 99% (w/v), from about 60% (w/v) to about 99% (w/v), from about 65% (w/v) to about 99% (w/v), from about 70% (w/v) to about 99% (w/v), from about 75% (w/v) to about 99% (w/v), from about 80% (w/v) to about 99% (w/v), from about 85% (w/v) to about 99% (w/v), from about 90% (w/v) to about 99% (w/v), or from about 95% (w/v) to about 99% (w/v). As another example, the concentration of the oleaginous base fluid in the invert emulsion treatment fluid may range from about 20% (w/v) to about 99% (w/v), from about 20% (w/v) to about 95% (w/v), from about 20% (w/v) to about 90% (w/v), from about 20% (w/v) to about 85% (w/v), from about 20% (w/v) to about 80% (w/v), from about 20% (w/v) to about 75% (w/v), from about 20% (w/v) to about 70% (w/v), from about 20% (w/v) to about 65% (w/v), from about 20% (w/v) to about 60% (w/v), from about 20% (w/v) to about 55% (w/v), from about 20% (w/v) to about 50% (w/v), from about 20% (w/v) to about 45% (w/v), from about 20% (w/v) to about 40% (w/v), from about 20% (w/v) to about 35% (w/v), from about 20% (w/v) to about 30% (w/v), or from about 20% (w/v) to about 25% (w/v). With the benefit of this disclosure, one of ordinary skill in the art will be able to prepare an invert emulsion treatment fluid having a sufficient concentration of an oleaginous base fluid for a given application.

The invert emulsion treatment fluid comprises an internal or discontinuous phase composed of an aqueous fluid. Examples of the aqueous fluid may include, but are not limited to, freshwater, saltwater (e.g., water containing one or more salts dissolved therein, such as found in produced water), brine (e.g., saturated saltwater, including saturated saltwater produced from subterranean formations), seawater, water soluble alcohols, water soluble glycols, water soluble amines, or any combination thereof. Generally, the aqueous fluid may be from any source provided that the aqueous fluid does not contain an excess of compounds that may undesirably affect other components in the invert emulsion treatment fluid. In the specific case of brines, the brine may comprise a monovalent brine or a divalent brine. Suitable monovalent brines may include, for example, sodium chloride brines, sodium bromide brines, potassium chloride brines, potassium bromide brines, potassium acetate brines, potassium formate brines, ammonium-containing brines such as ammonium chloride, ammonium bromide, ammonium nitrate, ammonium nitrite, ammonium acetate, ammonium formate, ammonium sulfate, ammonium carbonate, and ammonium hydroxide, and the like. Suitable divalent brines may include, for example, magnesium chloride brines, calcium chloride brines, calcium bromide brines, calcium nitrate brines, zinc chloride brines, zinc bromide brines, cesium formate brines and the like. For reasons of economics, supply, and availability, the use of seawater as a source of water is also plausible taking into account the variability in seawater chemistry; likewise, the use of produced water, which can have a high degree of chemical variability (ionic composition, pH, dissolved chemicals such as CO₂, H₂S) is further optional. One of ordinary skill in the art, with the benefit of this disclosure, should be readily able to select an aqueous fluid for the internal phase of the invert emulsion treatment fluid.

The concentration of the aqueous fluid in the invert emulsion treatment fluid may range from about 0.1% w/v to about 80% w/v. The concentration may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the aqueous fluid in the invert emulsion treatment fluid may range from about 0.1% (w/v) to about 80% (w/v), from about 0.5% (w/v) to about 80% (w/v), from about 1% (w/v) to about 80% (w/v), from about 2% (w/v) to about 80% (w/v), from about 3% (w/v) to about 80% (w/v), from about 4% (w/v) to about 80% (w/v), from about 5% (w/v) to about 80% (w/v), from about 6% (w/v) to about 80% (w/v), from about 7% (w/v) to about 80% (w/v), from about 8% (w/v) to about 80% (w/v), from about 9% (w/v) to about 80% (w/v), from about 10% (w/v) to about 80% (w/v), from about 11% (w/v) to about 80% (w/v), from about 12% (w/v) to about 80% (w/v), from about 13% (w/v) to about 80% (w/v), from about 14% (w/v) to about 80% (w/v), from about 15% (w/v) to about 80% (w/v), from about 16% (w/v) to about 80% (w/v), from about 17% (w/v) to about 80% (w/v), from about 18% (w/v) to about 80% (w/v), from about 19% (w/v) to about 80% (w/v), from about 20% (w/v) to about 80% (w/v), from about 21% (w/v) to about 80% (w/v), from about 22% (w/v) to about 80% (w/v), from about 23% (w/v) to about 80% (w/v), from about 24% (w/v) to about 80% (w/v), from about 25% (w/v) to about 80% (w/v), from about 30% (w/v) to about 80% (w/v), from about 35% (w/v) to about 80% (w/v), from about 40% (w/v) to about 80% (w/v), from about 45% (w/v) to about 80% (w/v), from about 50% (w/v) to about 80% (w/v), from about 55% (w/v) to about 80% (w/v), from about 60% (w/v) to about 80% (w/v), from about 65% (w/v) to about 80% (w/v), from about 70% (w/v) to about 80% (w/v), or from about 75% (w/v) to about 80% (w/v). As another example, the concentration of the aqueous fluid in the invert emulsion treatment fluid may range from about 0.1% (w/v) to about 80% (w/v), from about 0.1% (w/v) to about 75% (w/v), from about 0.1% (w/v) to about 70% (w/v), from about 0.1% (w/v) to about 65% (w/v), from about 0.1% (w/v) to about 60% (w/v), from about 0.1% (w/v) to about 55% (w/v), from about 0.1% (w/v) to about 50% (w/v), from about 0.1% (w/v) to about 45% (w/v), from about 0.1% (w/v) to about 40% (w/v), from about 0.1% (w/v) to about 35% (w/v), from about 0.1% (w/v) to about 30% (w/v), from about 0.1% (w/v) to about 25% (w/v), from about 0.1% (w/v) to about 24% (w/v), from about 0.1% (w/v) to about 23% (w/v), from about 0.1% (w/v) to about 22% (w/v), from about 0.1% (w/v) to about 21% (w/v), from about 0.1% (w/v) to about 20% (w/v), from about 0.1% (w/v) to about 19% (w/v), from about 0.1% (w/v) to about 18% (w/v), from about 0.1% (w/v) to about 17% (w/v), from about 0.1% (w/v) to about 16% (w/v), from about 0.1% (w/v) to about 15% (w/v), from about 0.1% (w/v) to about 14% (w/v), from about 0.1% (w/v) to about 13% (w/v), from about 0.1% (w/v) to about 12% (w/v), from about 0.1% (w/v) to about 11% (w/v), from about 0.1% (w/v) to about 10% (w/v), from about 0.1% (w/v) to about 9% (w/v), from about 0.1% (w/v) to about 8% (w/v), from about 0.1% (w/v) to about 7% (w/v), from about 0.1% (w/v) to about 6% (w/v), from about 0.1% (w/v) to about 5% (w/v), from about 0.1% (w/v) to about 4% (w/v), from about 0.1% (w/v) to about 3% (w/v), from about 0.1% (w/v) to about 2% (w/v), from about 0.1% (w/v) to about 1% (w/v), or from about 0.1% (w/v) to about 0.5% (w/v). With the benefit of this disclosure, one of ordinary skill in the art will be readily able to prepare an invert emulsion treatment fluid having a desirable concentration of aqueous fluid.

The invert emulsion treatment fluid comprises an emulsifier. The emulsifier may be from a class characterized as, but not limited to, ionic, non-ionic, cationic, anionic, zwitterionic, amphiphilic, or amphoteric. The emulsifier may be characterized by having a hydrophilic-lipophilic balance (HLB) value of, but not limited to, 1 to 18. Examples of the emulsifier may include, but are not limited to, alkanolamides, alkylamine alkoxylates, polyether polyamines, alkoxylated polyethylene amine, alkoxylated linear alcohols, alkoxylated branched alcohols, alkoxylated secondary alcohols, alkoxylated Guerbet alcohol, alkoxylated alkylphenol, alkoxylated fatty acids, castor oil ethoxylates, alkoxylated glycerol, alkyl glycosides, alkylamine-oxides, alkoxylated sorbitol, alkoxylated alkylphenol resin, ethylene oxide and propylene oxide block copolymers, reverse EO/PO block copolymers, polyether polyols, triethanolamine linear alkoxylate sulfonate, bis-oxo-diphenol-di-sulfonate, alkoxylated phosphate complexes, aliphatic phosphate, phosphate esters, acetylenic alkoxylated gemini surfactant, polyether siloxane copolymer, glycolipids such as sophorolipid, rhamnolipid, sorbitan-based surfactants, amidoamines, carboxylic acid terminated polyamines, or a combination of emulsifiers.

In some optional examples, emulsifier activators may be added to the invert emulsion treatment fluid. The emulsifier activators may be used to improve emulsifier performance, which may result in increased emulsion stability. Examples of the emulsifier activators generally include, but are not limited to, lime and/or caustic additives.

The concentration of the emulsifier in the invert emulsion treatment fluid may range from about 0.025% w/v to about 20% w/v. The concentration may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the emulsifier in the invert emulsion treatment fluid may range from about 0.025% (w/v) to about 20% (w/v), from about 0.05% (w/v) to about 20% (w/v), from about 0.075% (w/v) to about 20% (w/v), from about 0.1% (w/v) to about 20% (w/v), from about 0.5% (w/v) to about 20% (w/v), from about 1% (w/v) to about 20% (w/v), from about 2% (w/v) to about 20% (w/v), from about 3% (w/v) to about 20% (w/v), from about 4% (w/v) to about 20% (w/v), from about 5% (w/v) to about 20% (w/v), from about 6% (w/v) to about 20% (w/v), from about 7% (w/v) to about 20% (w/v), from about 8% (w/v) to about 20% (w/v), from about 9% (w/v) to about 20% (w/v), from about 10% (w/v) to about 20% (w/v), from about 11% (w/v) to about 20% (w/v), from about 12% (w/v) to about 20% (w/v), from about 13% (w/v) to about 20% (w/v), from about 14% (w/v) to about 20% (w/v), from about 15% (w/v) to about 20% (w/v), from about 16% (w/v) to about 20% (w/v), from about 17% (w/v) to about 20% (w/v), from about 18% (w/v) to about 20% (w/v), or from about 19% (w/v) to about 20% (w/v). As another example, the concentration of the emulsifier in the invert emulsion treatment fluid may range from about 0.025% (w/v) to about 20% (w/v), from about 0.025% (w/v) to about 19% (w/v), from about 0.025% (w/v) to about 18% (w/v), from about 0.025% (w/v) to about 17% (w/v), from about 0.025% (w/v) to about 16% (w/v), from about 0.025% (w/v) to about 15% (w/v), from about 0.025% (w/v) to about 14% (w/v), from about 0.025% (w/v) to about 13% (w/v), from about 0.025% (w/v) to about 12% (w/v), from about 0.025% (w/v) to about 11% (w/v), from about 0.025% (w/v) to about 10% (w/v), from about 0.025% (w/v) to about 9% (w/v), from about 0.025% (w/v) to about 8% (w/v), from about 0.025% (w/v) to about 7% (w/v), from about 0.025% (w/v) to about 6% (w/v), from about 0.025% (w/v) to about 5% (w/v), from about 0.025% (w/v) to about 4% (w/v), from about 0.025% (w/v) to about 3% (w/v), from about 0.025% (w/v) to about 2% (w/v), from about 0.025% (w/v) to about 1% (w/v), from about 0.025% (w/v) to about 0.5% (w/v), from about 0.025% (w/v) to about 0.1% (w/v), from about 0.025% (w/v) to about 0.075% (w/v), or from about 0.025% (w/v) to about 0.05% (w/v). With the benefit of this disclosure, one of ordinary skill in the art will be readily able to prepare an invert emulsion treatment fluid having a desirable concentration of emulsifier.

In some optional examples, the invert emulsion treatment fluid may comprise an additive. The additive may be used to adjust a property of the invert emulsion treatment fluid, for example, the viscosity, density, etc. Examples of the additive may include, but are not limited to, silica scale control additives, corrosion inhibitors, surfactants, gel stabilizers, anti-oxidants, polymer degradation prevention additives, scale inhibitors, foaming agents, defoaming agents, antifoaming agents, emulsifying agents, de-emulsifying agents, iron control agents, proppants or other particulates, particulate diverters, salts, fluid loss control additives, gas, catalysts, clay control agents, dispersants, flocculants, scavengers (e.g., H₂S scavengers, CO₂ scavengers or O₂ scavengers), gelling agents, lubricants, friction reducers, bridging agents, rheology modifiers, viscosifiers, weighting agents, solubilizers, hydrate inhibitors, consolidating agents, bactericides, clay stabilizers, breakers, delayed release breakers, lost-circulation materials, wellbore strengthening materials, suspending agents, pH adjustors the like, or any combination thereof. With the benefit of this disclosure, one of ordinary skill in the art will be able to formulate an invert emulsion treatment fluid having properties suitable for a desired wellbore operation.

Invert emulsion treatment fluids may be prepared at a mud plant and/or the wellsite. In some examples, additives to improve electrical conductivity may not be necessary. For example, the invert emulsion treatment fluid may omit carbon nanotubes or other additives that would otherwise increase the electrical conductivity of the invert emulsion treatment fluid. Optionally, the invert emulsion treatment fluid may also comprise other treatment fluid components such as polymeric additives and weighting agents. Examples of the polymeric additives may include, but are not limited to, fluid loss control additives, viscosifiers, rheology modifiers, suspension agents, polymeric emulsifiers, the like, or any combination thereof. In some examples, the sonication of the invert emulsion treatment fluid may be performed prior to the addition of a polymeric additive. Without limitation by theory, sonication may degrade some species of polymeric additives, and these polymeric additives may be added after sonication of the invert emulsion treatment fluid to mitigate potential degradation. Moreover, some solid additives such as weighting agents may also be added to the invert emulsion treatment fluid after sonication, as their absence during sonication may enhance the increase in the electrical stability of the invert emulsion treatment fluid. However, in some other examples, solids may be present during sonication.

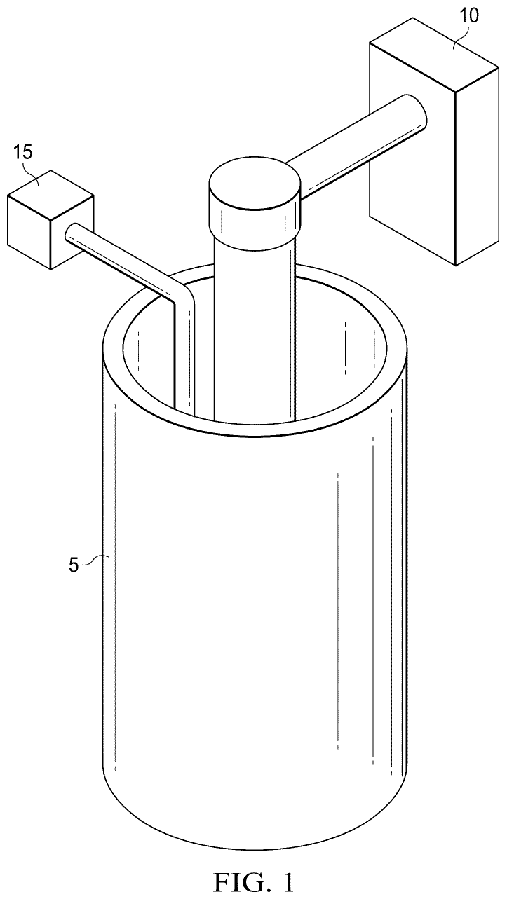

FIG. 1 illustrates a perspective drawing of the preparation of an invert emulsion treatment fluid. An oleaginous base fluid, an aqueous fluid, and an emulsifier are combined in vessel 5, in which the invert emulsion treatment fluid is formulated and prepared. In some optional examples, additional invert emulsion treatment fluid components may be combined with the oleaginous base fluid, aqueous fluid, and emulsifier at this initial combination stage or at later stages of preparation. In some examples, only the oleaginous base fluid, aqueous fluid, and emulsifier are used to form the invert emulsion treatment fluid. In some examples, only the oleaginous base fluid, aqueous fluid, and emulsifier are sonicated to form the invert emulsion treatment fluid and other components may not be added to the invert emulsion treatment fluid prior to sonication. In some examples, other treatment fluid components may be added to the invert emulsion treatment fluid after sonication. A sonicator 10 is used to sonicate the oleaginous base fluid, aqueous fluid, and emulsifier during and/or after their combination. Without limitation by theory, it is believed that the agitation provided by sonication induces cavitation in the invert emulsion treatment fluid which may reduce the droplet size of the internal phase of the invert emulsion. Reduction of the droplet size of the internal phase may improve stability of the invert emulsion treatment fluid and this improvement may be measured by an increase in the electrical stability of the invert emulsion treatment fluid.

Sonication may be performed at the mud plant, the wellsite, or both. In some examples, only the oleaginous base fluid, aqueous fluid, and emulsifier are sonicated to form the invert emulsion treatment fluid, and other components may not be added to the invert emulsion treatment fluid prior to sonication. In other examples, additional treatment fluid components may be added during and/or after combination of the oleaginous base fluid, aqueous fluid, and emulsifier. If sonication has already occurred, the invert emulsion treatment fluid may be sonicated again after the addition of other treatment fluid components. This additional sonication is optional and may not be performed in all examples. In some operations, the sonicated invert emulsion treatment fluid may be added as a seed fluid to a second treatment fluid which has not been sonicated. The addition of the seed fluid invert emulsion treatment fluid to a second treatment fluid may be done at the mud plant or the wellsite.

With continued reference to FIG. 1, an electrical stability tester 15 may be used to measure the electrical stability of the invert emulsion treatment fluid prior to, during, and/or after it is formulated and/or sonicated in the vessel 5. In some examples, the electrical stability is not measured and a known specific energy is applied to the invert emulsion treatment fluid, which provides a sufficient increase in the electrical stability. In some further optional examples, the agitation performed by the sonicator 10 may be automated to apply sufficient specific energy per a known volume and formulation of the invert emulsion treatment fluid. Optionally, the electrical stability tester 15 may be automated to measure the electrical stability at a specific time interval(s). Should the electrical stability pass a desired threshold value, sonication would cease. Should the electrical stability not pass the desired threshold value, this sonication and measurement cycle would repeat until the measured electrical stability exceeds the desired threshold value. The electrical stability may be measured at the mud plant or the wellsite. In some examples, the electrical stability may be measured after storing of the invert emulsion treatment fluid to determine if sonication may be needed prior to use. For example, the electrical stability may be measured after the invert emulsion treatment fluid has been stored at the wellsite or mud plant for a period of hours, days, or weeks. After the preparation of the invert emulsion treatment fluid is completed, the treatment fluid may be used to perform an operation in a subterranean formation, such as drilling a wellbore or completing a previously drilled wellbore.

It should be clearly understood that the example system illustrated by FIG. 1 is merely a general application of the principles of this disclosure in practice, and a wide variety of other examples are possible. Therefore, the scope of this disclosure is not limited in any manner to the details of FIG. 1 as described herein.

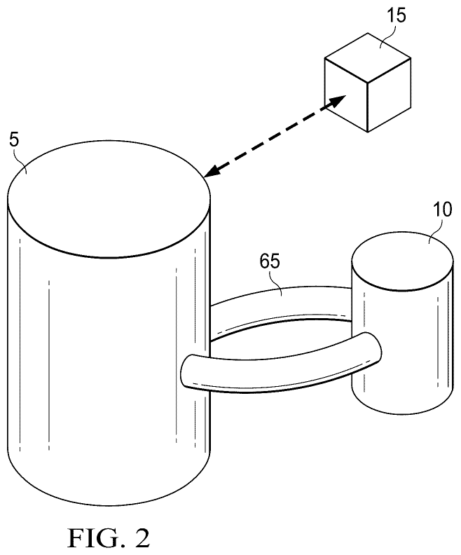

FIG. 2 is another illustration of a perspective drawing of the preparation of an invert emulsion treatment fluid. Unlike in FIG. 1, the example of FIG. 2 separates the sonicator 10 and electrical stability tester 15 from the vessel 5. An oleaginous base fluid, aqueous fluid, and an emulsifier are combined in vessel 5 in which the invert emulsion treatment fluid is formulated and prepared. In some optional examples, additional invert emulsion treatment fluid components may be combined with the oleaginous base fluid, aqueous fluid, and emulsifier at this initial combination stage or at later stages of preparation. In some examples, only the oleaginous base fluid, aqueous fluid, and emulsifier are used to form the invert emulsion treatment fluid. In some examples, only the oleaginous base fluid, aqueous fluid, and emulsifier are sonicated to form the invert emulsion treatment fluid and other components may not be added to the invert emulsion treatment fluid prior to sonication. In some examples, other treatment fluid components may be added to the invert emulsion treatment fluid after sonication.

A sonicator 10 is located separately from the vessel 5. The sonicator 10 is connected to the vessel 5 with a conduit 65 such as tubing or piping. Although not illustrated, a pump or other such mechanism may be used to draw the invert emulsion treatment fluid or its components from the vessel 5 and push it to the sonicator 10 via conduit 65. The sonicator 10 is used to sonicate the oleaginous base fluid, aqueous fluid, and emulsifier during and/or after their combination. Without limitation by theory, it is believed that the agitation provided by sonication induces cavitation in the invert emulsion treatment fluid which may reduce the droplet size of the internal phase of the invert emulsion. Reduction of the droplet size of the internal phase may improve stability of the invert emulsion treatment fluid and this improvement may be measured by an increase in the electrical stability of the invert emulsion treatment fluid. After sonication, the invert emulsion treatment fluid or its components are pumped back to the vessel 5 via conduit 65.

As with FIG. 1, the sonication operation may be performed at the mud plant, the wellsite, or both. In some examples, only the oleaginous base fluid, aqueous fluid, and emulsifier are sonicated to form the invert emulsion treatment fluid and other components may not be added to the invert emulsion treatment fluid prior to sonication. In other examples, additional treatment fluid components may be added during and/or after combination of the oleaginous base fluid, aqueous fluid, and emulsifier. If sonication has already occurred, the invert emulsion treatment fluid may be sonicated again after the addition of other treatment fluid components. This additional sonication is optional and may not be performed in all examples. In some operations, the sonicated invert emulsion treatment fluid may be added as a seed fluid to a second treatment fluid which has not been sonicated. The addition of the seed fluid invert emulsion treatment fluid to a second treatment fluid may be done at the mud plant or the wellsite.

Continuing with FIG. 2, an electrical stability tester 15 may be used to measure the electrical stability of the invert emulsion treatment fluid prior to, during, and/or after it is formulated in the vessel 5. In some examples, the electrical stability is not measured and a known specific energy is applied to the invert emulsion treatment fluid which provides a sufficient increase in the electrical stability. In some further optional examples, the agitation performed by the sonicator 10 may be automated to apply sufficient specific energy per a known volume and formulation of the invert emulsion treatment fluid. In the example of FIG. 2, the electrical stability tester 15 is separated from the vessel 5. A sample of the invert emulsion treatment fluid may be removed from the vessel 5, walked to the electrical stability tester 15, and placed in the electrical stability tester 15 for testing. In some alternative examples, the electrical stability tester 15 may be moved to the vessel 5 or conduit 65 and used to test a sample residing within vessel 5 and/or conduit 65 or used to test a sample from one or both of the vessel 5 and conduit 65. The electrical stability may be measured at the mud plant or the wellsite. In some examples, the electrical stability may be measured after storing of the invert emulsion treatment fluid to determine if sonication may be needed prior to use. For example, the electrical stability may be measured after the invert emulsion treatment fluid has been stored at the wellsite or mud plant for a period of hours, days, or weeks. After the preparation of the invert emulsion treatment fluid is completed, the treatment fluid may be used to perform an operation in a subterranean formation, such as drilling a wellbore or completing a previously drilled wellbore.

It should be clearly understood that the example system illustrated by FIG. 2 is merely a general application of the principles of this disclosure in practice, and a wide variety of other examples are possible. Therefore, the scope of this disclosure is not limited in any manner to the details of FIG. 2 as described herein.

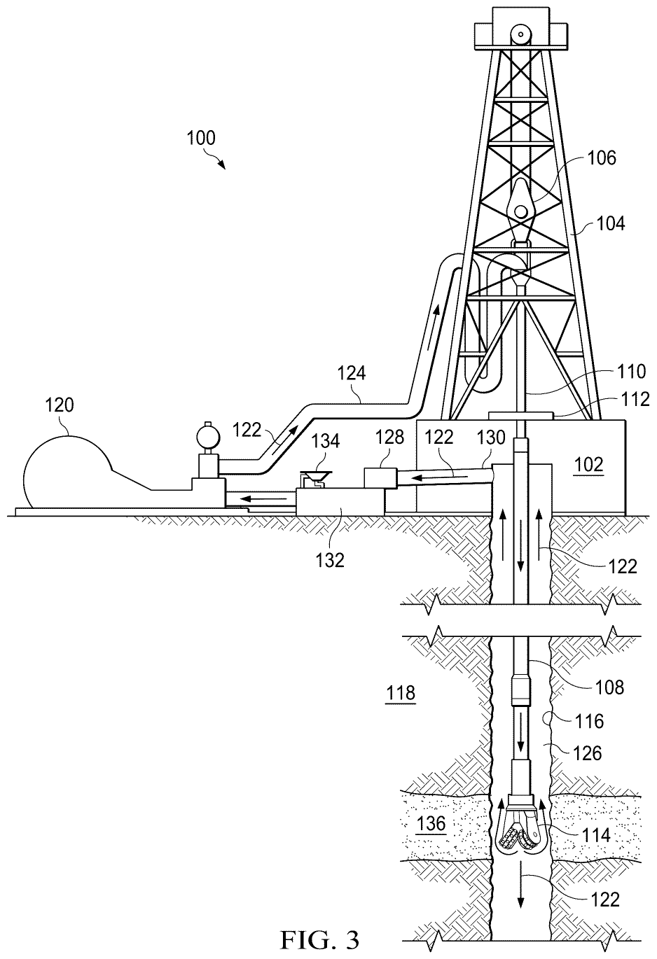

FIG. 3 illustrates a schematic for drilling a subterranean formation with an invert emulsion drilling fluid 122. It should be noted that while FIG. 3 generally depicts a land-based drilling assembly, those skilled in the art will readily recognize that the principles described herein are equally applicable to subsea drilling operations that employ floating or sea-based platforms and rigs, without departing from the scope of the disclosure. In the illustrated example, the drilling fluid 122 has been sonicated with a sonicator as described in FIGS. 1 and 2. This sonication occurs prior to the use of the drilling fluid to drill the subterranean formation 118 and may be done at the wellsite and/or the mud plant.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, as is generally known to those skilled in the art. A kelly 110 may support the drill string 108 as it is lowered through a rotary table 112. A drill bit 114 may be attached to the distal end of the drill string 108 and may be driven either by a downhole motor and/or via rotation of the drill string 108 from the well surface. The drill bit 114 may include, but is not limited to roller cone bits, PDC bits, natural diamond bits, any hole openers, reamers, coring bits, etc. As the drill bit 114 rotates, it may create a wellbore 116 that penetrates various subterranean formations 118. In a specific example, the drill bit 114 penetrates reservoir section 136 while the drilling fluid 122 is circulated in the wellbore 116 during the drilling of the reservoir section 136.

A pump 120 (e.g., a mud pump) may circulate the drilling fluid 122 through a feed pipe 124 and to the kelly 110, which conveys the drilling fluid 122 downhole through the interior of the drill string 108 and through one or more orifices in the drill bit 114 and into the wellbore 116 portion penetrating the reservoir section 136. The drilling fluid 122 may then lubricate the drill bit 114 as well as carry cuttings to the surface.

The drilling fluid 122 is circulated back to the surface via annulus 126 defined between the drill string 108 and the walls of the wellbore 116. At the surface, the drilling fluid 122 may exit the annulus 126 and be conveyed to one or more fluid processing unit(s) 128 via an interconnecting flow line 130. The fluid processing unit(s) 128 may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, and/or any fluid reclamation equipment. The fluid processing unit(s) 128 may further include one or more sensors, gauges, pumps, compressors, and the like used store, monitor, regulate, and/or recondition the drilling fluid 122.

After passing through the fluid processing unit(s) 128, a “cleaned” drilling fluid 122 may be deposited into a nearby retention pit 132 (i.e., a mud pit). While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the scope of the disclosure. One or more drilling fluid additives may be added to the drilling fluid 122 via a mixing hopper 134 communicably coupled to or otherwise in fluid communication with the retention pit 132. In some examples, the drilling fluid additives comprise additional amounts of the drilling fluid components (e.g., the oleaginous base fluid, aqueous fluid, emulsifier etc.) that may be added to the drilling fluid 122 via the mixing hopper. The mixing hopper 134 may include, but is not limited to, mixers and related mixing equipment known to those skilled in the art. Alternatively, the drilling fluid additives may be added to the drilling fluid 122 at any other location in the drilling assembly 100. While FIG. 3 shows only a single retention pit 132, there could be more than one retention pit 132, such as multiple retention pits 132 in series. Moreover, retention pit 132 may be representative of one or more fluid storage facilities and/or units where the drilling fluid additives may be stored, reconditioned, and/or regulated until added to the drilling fluid 122. In some optional examples, the cleaned drilling fluid 122 may be sonicated prior to being reintroduced into the wellbore 116. In further optional examples, the electrical stability of the cleaned drilling fluid 122 may be measured prior to, during, and/or after sonication of the cleaned drilling fluid 122.

It is to be recognized that system 100 is merely exemplary in nature, and various additional components may be present that have not necessarily been depicted in FIG. 3 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

It should be clearly understood that the examples illustrated by FIG. 3 are merely a general application of the principles of this disclosure in practice, and a wide variety of other examples are possible. Therefore, the scope of this disclosure is not limited in any manner to the details of FIG. 3 as described herein.

The invert emulsion treatment fluid disclosed herein may directly or indirectly affect one or more components or pieces of equipment associated with or which may come into contact with the invert emulsion treatment fluid such as, but not limited to, wellbore casing, wellbore liner, completion string, insert strings, drill string, coiled tubing, slickline, wireline, drill pipe, drill collars, mud motors, downhole motors and/or pumps such as electric submersible pumps (ESPs), cement pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), jetting tools, sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

To facilitate a better understanding of the present embodiments, the following examples of certain aspects of some embodiments are given. In no way should the following examples be read to limit, or define, the entire scope of the embodiments.

### Examples

An experiment was conducted to compare the electrical stability of a formulation of the invert emulsion treatment fluid. A formulation consisting of 231.35 mL of an oleaginous base fluid, 6.5 g of an emulsifier, and 105 mL of a CaCl₂) brine (aqueous fluid with a specific gravity of 1.12) were combined to produce an invert emulsion treatment fluid. The formulation was split into two samples. An experimental sample was sonicated with 15 J/mL, and the control sample was set aside and was not sonicated. The electrical stability was measured after preparation and sonication of the experimental test sample. The control sample had an electrical stability of 59 V peak voltage. The sonicated sample had an electrical stability of 113 V peak voltage. Next, the two samples were allowed to sit for one hour. After one hour, the control sample visually showed a clear phase separation, and the experimental sonicated sample did not.

Additional treatment fluid components were then added to the sonicated sample. To do this, 344 mL of the sonicated invert emulsion treatment fluid was combined with 6 g of lime powder, 5 g of organophilic clay, and 0.5 g of a polymeric fluid loss additive. This formulation is provided below in Table 1. The sample was then mixed on a multimixer. The sample was not sonicated again. This unweighted (contained no weighting agent) invert emulsion treatment fluid was measured to have an electrical stability of 482 V peak voltage. The same formulation listed in Table 1 was created again as a control, by mixing only on a multimixer without applying any ultrasonic energy, and was measured to have an electrical stability of 206 V peak voltage (i.e., without sonication).

TABLE 1
Unweighted Invert Emulsion Treatment Fluid Formulation.

| Component/Property | Units | Quantity |
|---|---|---|
| Density (SG) | lb/gal (no units) | 7.51 (0.90) |
| Oil/Water Ratio (v/v) | (no units) | 70/30 |
| Oleaginous Base Fluid | mL | 231.4 |
| Emulsifier | g | 6.5 |
| Lime | g | 6 |
| Organophilic Clay | g | 5 |
| Polymeric Fluid Loss Additive | g | 0.5 |
| Aqueous Fluid (CaCl₂ Brine) | mL | 105 |

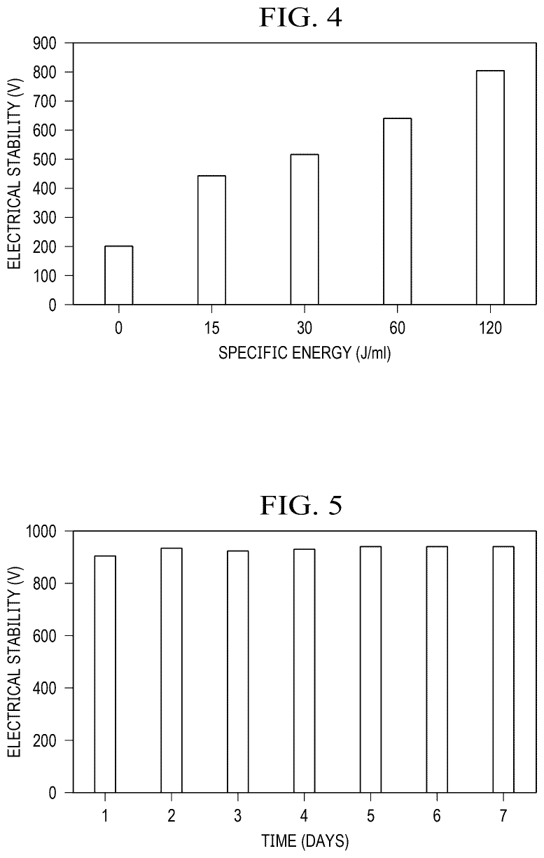

Further experimentation was performed to measure some additional effects of sonication on the same formulation of unweighted invert emulsion treatment fluid used in the previous experiment. The same formulation listed in Table 1 was first fully mixed again with a multimixer. This sample again measured an electrical stability of 206 V peak voltage. Subsequently, differing amounts of specific energy were applied to this exact sample with a sonicator, and the electrical stability was measured after sonication. The results of this experimentation are illustrated by the graph of FIG. 4, where the increasing specific energy resulted in an increase in electrical stability and shows that electrical stability is a function of the specific energy applied to the invert emulsion treatment fluid.

The sample in FIG. 4 that received 120 J/mL of specific energy was stored, and the electrical stability was measured each day for a period of seven days. The results of this experiment are illustrated by the graph of FIG. 5. The results indicate that the electrical stability improvement provided by sonication is not transient.

Another formulation was prepared to produce a weighted invert emulsion treatment fluid sample. This formulation is provided in Table 2.

TABLE 2
Weighted Invert Emulsion Treatment Fluid Formulation.

| Component/Property | Units | Quantity |
|---|---|---|
| Oleaginous Base Fluid | g | 154 |
| Emulsifier | g | 6.5 |
| Lime | g | 6 |
| Organophilic Clay | g | 5 |
| Polymeric Fluid Loss Additive | g | 0.5 |
| Total Wt. of Aqueous Fluid | g | 98 |
| (CaCl₂ Brine) | | |
| Weighting Agent (Barite) | g | 233.7 |

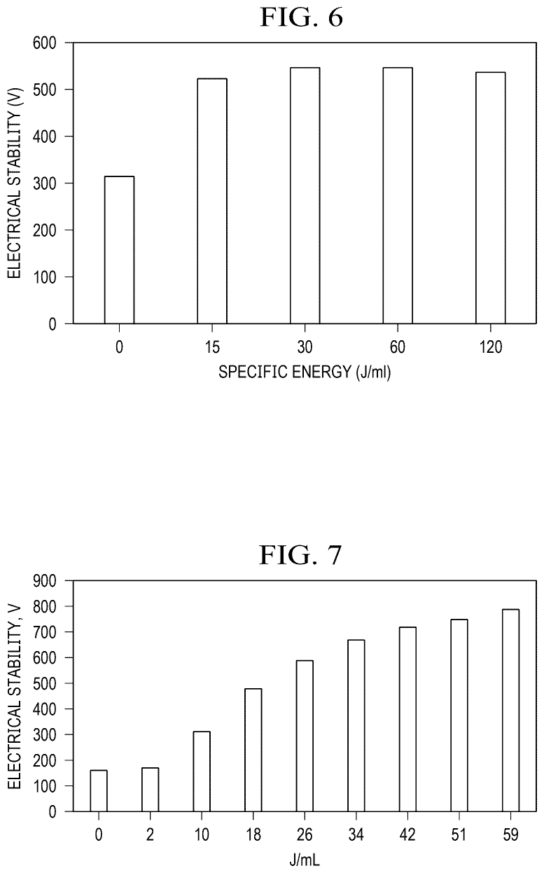

The formulation of Table 2 was mixed on a multimixer and then sonicated to apply different amounts of specific energy. The results of this experiment are illustrated by the graph of FIG. 6. The results illustrate that the electrical stability may be improved by sonication even with weighted invert emulsion treatment fluids.

Another unweighted formulation of an invert emulsion treatment fluid was prepared and tested. This formulation is provided in Table 3.

TABLE 3
Unweighted Invert Emulsion Treatment Fluid Formulation.

| Component/Property | Units | Quantity |
|---|---|---|
| Water | g | 78.67 |
| CaCl₂ Salt (Powder) | g | 23.08 |
| Oleaginous Base Fluid | g | 144.61 |
| Emulsifier | g | 14 |
| Lime | g | 4 |
| Clay | g | 8.2 |

The formulation of Table 3 was mixed on a multimixer and then sonicated to apply different amounts of specific energy, except for the control. The results are illustrated by the graph of FIG. 7. The results illustrate that the electrical stability may be improved by increasing the specific energy applied via sonication.

Provided are methods for preparing an invert emulsion treatment fluid in accordance with the disclosure and the illustrated FIGs. An example method comprises combining an oleaginous base fluid, an aqueous fluid, and an emulsifier to provide the invert emulsion treatment fluid and sonicating the invert emulsion treatment fluid during and/or after the combining of the oleaginous base fluid, aqueous fluid, and emulsifier.

Additionally, or alternatively, the method may include one or more of the following features individually or in combination. The method may further comprise adding a polymeric fluid loss additive after the sonicating. The method may further comprise adding a polymeric fluid loss additive before the sonicating. The method may further comprise adding a weighting agent after the sonicating. The method may further comprise adding a weighting agent before the sonicating. The method may further comprise adding the invert emulsion treatment fluid to a second treatment fluid and the second treatment fluid is not sonicated. The method may further comprise measuring the electrical stability of the invert emulsion treatment fluid after the sonicating. The method may further comprise sonicating the invert emulsion treatment fluid again if the measured electrical stability is less than a predetermined threshold electrical stability value. The oleaginous base fluid, aqueous fluid, and emulsifier may be combined prior to the sonicating and the method may further comprise measuring the electrical stability of the invert emulsion treatment fluid after combining the oleaginous base fluid, aqueous fluid, and emulsifier but before the sonicating. The method may further comprise sonicating the invert emulsion treatment fluid to increase the measured electrical stability by at least 25%. The sonicating may apply specific energy to the invert emulsion treatment fluid in a range of about 5 to about 200 J/mL. In some examples, the invert emulsion treatment fluid may not be a Pickering emulsion. The oleaginous base fluid may comprise an oleaginous base fluid selected from the group consisting of a fractional distillate of crude oil; a fatty derivative of an acid, an ester, an ether, an alcohol, an amine, an amide, or an imide; a saturated hydrocarbon; an unsaturated hydrocarbon; a branched hydrocarbon; a cyclic hydrocarbon; and any combination thereof. The aqueous fluid may comprise an aqueous fluid selected from the group consisting of freshwater, saltwater, brine, seawater, water soluble alcohols, water soluble glycols, water soluble amines, and any combination thereof. The emulsifier may comprise an emulsifier selected from the group consisting of alkanolamides, alkylamine alkoxylates, polyether polyamines, alkoxylated polyethylene amine, alkoxylated linear alcohols, alkoxylated branched alcohols, alkoxylated secondary alcohols, alkoxylated Guerbet alcohol, alkoxylated alkylphenol, alkoxylated fatty acids, castor oil ethoxylates, alkoxylated glycerol, alkyl glycosides, alkylamine-oxides, alkoxylated sorbitol, alkoxylated alkylphenol resin, ethylene oxide and propylene oxide block copolymers, reverse EO/PO block copolymers, polyether polyols, triethanolamine linear alkoxylate sulfonate, bis-oxo-diphenol-di-sulfonate, alkoxylated phosphate complexes, aliphatic phosphate, phosphate esters, acetylenic alkoxylated gemini surfactant, polyether siloxane copolymer, glycolipids such as sophorolipid, rhamnolipid, sorbitan-based surfactants, amidoamines, carboxylic acid terminated polyamines, and any combination thereof. The method may further comprise drilling a subterranean formation with the invert emulsion treatment fluid.

Provided are systems for preparing an invert emulsion treatment fluid in accordance with the disclosure and the illustrated FIGs. The system comprises an invert emulsion treatment fluid comprising an oleaginous base fluid, an aqueous fluid, and an emulsifier. The system further comprises a sonicator configured to sonicate the invert emulsion treatment fluid during and/or after combining the oleaginous base fluid, the aqueous fluid, and the emulsifier.

Additionally, or alternatively, the system may include one or more of the following features individually or in combination. The system may further comprise an electrical stability tester to measure the electrical stability of the invert emulsion treatment fluid. The electrical stability tester may be configured to measure the electrical stability at predetermined time intervals automatically and the sonicator is further configured to sonicate the invert emulsion treatment fluid automatically if the measured electrical stability is below a predetermined threshold electrical stability value. The sonicator may be further configured to stop sonicating the invert emulsion treatment fluid automatically if the electrical stability is measured to be above the predetermined threshold electrical stability value. The sonicator may be configured to apply specific energy to the invert emulsion treatment fluid in a range of about 5 to about 200 J/mL. The system may further comprise a drill string and a drill bit and the invert emulsion treatment fluid may be pumped through the drill string and the drill bit and into a wellbore penetrating a subterranean formation. The invert emulsion treatment fluid may not be a Pickering emulsion. The oleaginous base fluid may comprise an oleaginous base fluid selected from the group consisting of a fractional distillate of crude oil; a fatty derivative of an acid, an ester, an ether, an alcohol, an amine, an amide, or an imide; a saturated hydrocarbon; an unsaturated hydrocarbon; a branched hydrocarbon; a cyclic hydrocarbon; and any combination thereof. The aqueous fluid may comprise an aqueous fluid selected from the group consisting of freshwater, saltwater, brine, seawater, water soluble alcohols, water soluble glycols, water soluble amines, and any combination thereof. The emulsifier may comprise an emulsifier selected from the group consisting of alkanolamides, alkylamine alkoxylates, polyether polyamines, alkoxylated polyethylene amine, alkoxylated linear alcohols, alkoxylated branched alcohols, alkoxylated secondary alcohols, alkoxylated Guerbet alcohol, alkoxylated alkylphenol, alkoxylated fatty acids, castor oil ethoxylates, alkoxylated glycerol, alkyl glycosides, alkylamine-oxides, alkoxylated sorbitol, alkoxylated alkylphenol resin, ethylene oxide and propylene oxide block copolymers, reverse EO/PO block copolymers, polyether polyols, triethanolamine linear alkoxylate sulfonate, bis-oxo-diphenol-di-sulfonate, alkoxylated phosphate complexes, aliphatic phosphate, phosphate esters, acetylenic alkoxylated gemini surfactant, polyether siloxane copolymer, glycolipids such as sophorolipid, rhamnolipid, sorbitan-based surfactants, amidoamines, carboxylic acid terminated polyamines, and any combination thereof.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps. The systems and methods can also “consist essentially of or” consist of the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited. In the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

One or more illustrative examples incorporating the examples disclosed herein are presented. Not all features of a physical implementation are described or shown in this application for the sake of clarity. Therefore, the disclosed systems and methods are well adapted to attain the ends and advantages mentioned, as well as those that are inherent therein. The particular examples disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown other than as described in the claims below. It is therefore evident that the particular illustrative examples disclosed above may be altered, combined, or modified, and all such variations are considered within the scope of the present disclosure. The systems and methods illustratively disclosed herein may suitably be practiced in the absence of any element that is not specifically disclosed herein and/or any optional element disclosed herein.

Although the present disclosure and its advantages have been described in detail, it should be understood that various changes, substitutions and alterations can be made herein without departing from the spirit and scope of the disclosure as defined by the following claims.

1. A method for preparing an invert emulsion treatment fluid,
the method comprises:
combining an oleaginous base fluid, an aqueous fluid, and an emulsifier, and sonicating the combination of the oleaginous base fluid, aqueous fluid, and emulsifier during and/or after the combining of the oleaginous base fluid, aqueous fluid, and emulsifier to provide the invert emulsion treatment fluid;
wherein the invert emulsion treatment fluid is not a Pickering emulsion.

2. The method of claim 1, further comprising adding a polymeric fluid loss additive after the sonicating.

3. The method of claim 1, further comprising adding a polymeric fluid loss additive before the sonicating.

4. The method of claim 1, further comprising adding a weighting agent after the sonicating.

5. The method of claim 1, further comprising adding a weighting agent before the sonicating.

6. The method of claim 1, further comprising adding the invert emulsion treatment fluid to a second treatment fluid; wherein the second treatment fluid is not sonicated.

7. The method of claim 1, further comprising measuring an electrical stability of the invert emulsion treatment fluid after the sonicating.

8. The method of claim 7, further comprising sonicating the invert emulsion treatment fluid again if the measured electrical stability is less than a predetermined threshold electrical stability value.

9. The method of claim 1, wherein the oleaginous base fluid, aqueous fluid, and emulsifier are combined prior to the sonicating; wherein the method further comprises measuring an electrical stability of the invert emulsion treatment fluid after combining the oleaginous base fluid, aqueous fluid, and emulsifier but before the sonicating; wherein the method further comprises sonicating the invert emulsion treatment fluid to increase the measured electrical stability.

10. The method of claim 1, wherein the sonicating applies specific energy to the invert emulsion treatment fluid in a range of about 5 to about 200 J/mL.

11. The method of claim 1, wherein the sonicating is applied to the invert emulsion treatment fluid at a frequency between about 1 to about 170 kHz.

12. (canceled)

13. The method of claim 1, wherein the oleaginous base fluid comprises a fractional distillate of crude oil; a fatty derivative of an acid, an ester, an ether, an alcohol, an amine, an amide, or an imide; a saturated hydrocarbon; an unsaturated hydrocarbon; a branched hydrocarbon; a cyclic hydrocarbon; or any combination thereof.

14. The method of claim 1, wherein the emulsifier comprises an alkanolamide, alkylamine alkoxylate, polyether polyamine, alkoxylated polyethylene amine, alkoxylated linear alcohol, alkoxylated branched alcohol, alkoxylated secondary alcohol, alkoxylated Guerbet alcohol, alkoxylated alkylphenol, alkoxylated fatty acid, castor oil ethoxylate, alkoxylated glycerol, alkyl glycoside, alkylamine-oxide, alkoxylated sorbitol, alkoxylated alkylphenol resin, ethylene oxide and propylene oxide block copolymer, reverse EO/PO block copolymer, polyether polyol, triethanolamine linear alkoxylate sulfonate, bis-oxo-diphenol-di-sulfonate, alkoxylated phosphate complex, aliphatic phosphate, phosphate ester, acetylenic alkoxylated gemini surfactant, polyether siloxane copolymer, a glycolipid such as sophorolipid, rhamnolipid, sorbitan-based surfactant, amidoamine, a carboxylic acid terminated polyamine, or any combination thereof.

15. The method of claim 1, further comprising drilling a subterranean formation with the invert emulsion treatment fluid.

16. A system for preparing an invert emulsion treatment fluid, the system comprises:
an invert emulsion treatment fluid comprising a combination of:
an oleaginous base fluid,
an aqueous fluid, and
an emulsifier; wherein the invert emulsion treatment fluid is not a Pickering emulsion; and
a sonicator configured to sonicate the invert emulsion treatment fluid during and/or after combining the oleaginous base fluid, the aqueous fluid, and the emulsifier to form the invert emulsion treatment fluid.

17. The system of claim 16, further comprising an electrical stability tester configured to measure the electrical stability of the invert emulsion treatment fluid.

18. The system of claim 17, wherein the electrical stability tester is configured to measure the electrical stability of the invert emulsion treatment fluid at predetermined time intervals, and wherein the sonicator is further configured to sonicate the invert emulsion treatment fluid if the measured electrical stability is below a predetermined threshold electrical stability value; wherein the sonicator is further configured to stop sonicating the invert emulsion treatment fluid if the electrical stability is measured to be above the predetermined threshold electrical stability value.

19. The system of claim 16, wherein the sonicator is configured to apply specific energy to the invert emulsion treatment fluid in a range of about 5 to about 200 J/mL.

20. The system of claim 16, further comprising a drill string and a drill bit; wherein the system is configured to pump the invert emulsion treatment fluid through the drill string and the drill bit and into a wellbore penetrating a subterranean formation.

21. The system of claim 16, wherein the sonicator is configured to sonicate the invert emulsion treatment fluid at a frequency between about 1 to about 170 kHz.
